(19) United States
(12) Patent Application Publication
(10) Pub. No.: US 2015/0291842 A1
(43) Pub. Date: Oct. 15, 2015

(54) Positive Photosensitive Resin Composition, Photosensitive Resin Film and Display Device Using the Same

(71) Applicant: Samsung SDI Co., Ltd., Yongin-si (KR)

(72) Inventors: Sang-Soo KIM, Suwon-si (KR); Jin-Hee KANG, Suwon-si (KR); Yong-Tae KIM, Suwon-si (KR); Kun-Bae NOH, Suwon-si (KR); Jae-Yeol BAEK, Suwon-si (KR); Han-Sung YU, Suwon-si (KR); Bum-Jin LEE, Suwon-si (KR); Sang-Haeng LEE, Suwon-si (KR); Jong-Hwa LEE, Suwon-si (KR); Jin-Young LEE, Suwon-si (KR)

(21) Appl. No.: 14/521,808

(22) Filed: Oct. 23, 2014

(30) Foreign Application Priority Data
Apr. 10, 2014 (KR) 10-2014-0043252

(51) Int. Cl. C09D 177/00; C09D 171/00; C09D 133/00

(52) U.S. Cl. CPC C09D 177/00; C09D 133/00; C09D 171/00

(57) ABSTRACT

A positive photosensitive resin composition includes (A) an alkali soluble resin including a repeating unit represented by the following Chemical Formula 1, wherein in Chemical Formula 1, each substituent is the same as defined in the detailed description; (B) a photosensitive diazoquinone compound; and (C) a solvent, a photosensitive resin film, and a display device including the same.

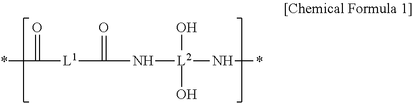

### CROSS-REFERENCE TO RELATED APPLICATION

This application claims priority to and the benefit of Korean Patent Application No. 10-2014-0043252 filed in the Korean Intellectual Property Office on Apr. 10, 2014, the entire disclosure of which is incorporated herein by reference.

### FIELD OF THE INVENTION

The present invention relates to a positive photosensitive resin composition, and a photosensitive resin film using the same display device.

### BACKGROUND

The conventional surface protective layer and interlayer insulating layer for a semiconductor device includes a polyimide resin or a polybenzoxazole resin as an alkali soluble resin having excellent heat resistance, electrical characteristics, mechanical characteristics, and the like. Such resins have recently been used in a form of a photosensitive polyimide precursor or polybenzoxazole precursor composition, and thus easily coated. The compositions are coated on a substrate for a semiconductor or a display, patterned by ultraviolet (UV) rays, developed, and thermally imidized, to form a surface protective layer, an interlayer insulating film, and the like.

An alkali soluble resin composition may be applied as a positive type in which an exposed part is developed and dissolved or as a negative type in which the exposed part is cured and maintained. The positive-type alkali soluble resin composition may use a non-toxic alkali aqueous solution as a developing solution but may not provide a desired tapered angle during thermal curing after development in terms of process characteristics or may result in decreased shrinkage ratio after the thermal curing.

In order to solve this problem, a cross-linking agent may be added thereto. Adding a cross-linking agent, however, can change optical properties, and thus, stability can be hard to secure.

Accordingly, there is a need for an alkali soluble resin composition having a desired tapered angle and a high shrinkage ratio without using a cross-linking agent.

### SUMMARY

One embodiment provides a positive photosensitive resin composition that can have a high shrinkage ratio and excellent durability.

Another embodiment provides a photosensitive resin film manufactured using the positive photosensitive resin composition.

Yet another embodiment provides a display device including the photosensitive resin film.

One embodiment provides a positive photosensitive resin composition including (A) an alkali soluble resin including a repeating unit represented by the following Chemical Formula 1; (B) a photosensitive diazoquinone compound; and (C) a solvent.

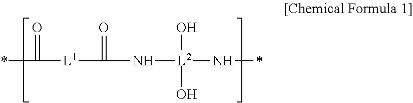

In the above Chemical Formula 1,

L¹ is represented by the following Chemical Formula 2.

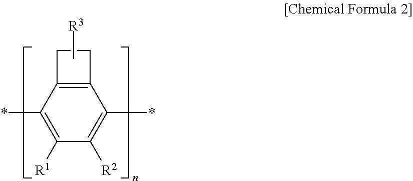

In the above Chemical Formula 2,

R¹ to R³ are the same or different and are each independently hydrogen, halogen, substituted or unsubstituted C1 to C20 alkyl, or substituted or unsubstituted C6 to C20 aryl, wherein R¹ and R² are optionally fused to each other to form a ring, and

n is an integer ranging from 1 to 10.

In the above Chemical Formula 1,

L² is a substituted or unsubstituted C6 to C30 aromatic organic group.

The above Chemical Formula 2 may be represented by one of the following Chemical Formulae 3 to 6.

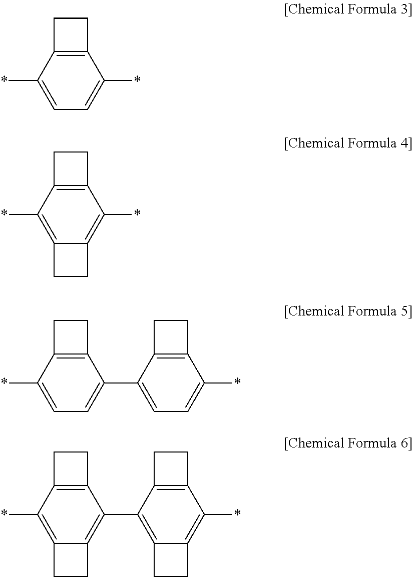

The repeating unit represented by the above Chemical Formula 1 may be included in an amount of about 5 wt % to about 60 wt % based on the total amount of the alkali soluble resin.

The alkali soluble resin may further include a repeating unit represented by the following Chemical Formula 7, a repeating unit represented by the following Chemical Formula 8, or a combination thereof.

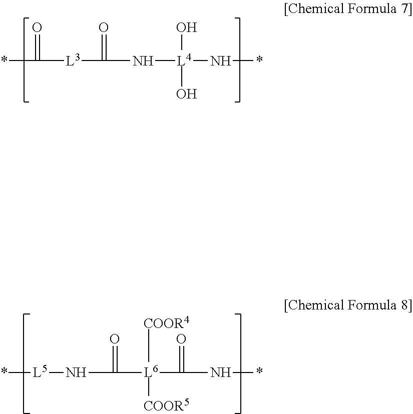

In the above Chemical Formulae 7 and 8,

L³ is a substituted or unsubstituted C6 to C30 aromatic organic group, a substituted or unsubstituted divalent C1 to C30 aliphatic organic group, or a substituted or unsubstituted divalent C3 to C30 alicyclic organic group,

L⁴ is a substituted or unsubstituted C6 to C30 aromatic organic group,

L⁵ is a substituted or unsubstituted C6 to C30 aromatic organic group, a substituted or unsubstituted divalent C1 to C30 aliphatic organic group, a substituted or unsubstituted divalent C3 to C30 alicyclic organic group, or an organosilane group,

L⁶ is a substituted or unsubstituted C6 to C30 aromatic organic group, a substituted or unsubstituted tetravalent C1 to C30 aliphatic organic group, or a substituted or unsubstituted tetravalent C3 to C30 alicyclic organic group, and

R⁴ and R⁵ are the same or different and are each independently hydrogen, halogen, substituted or unsubstituted C1 to C20 alkyl, or substituted or unsubstituted C6 to C20 aryl.

The alkali soluble resin may further include an acrylic-based resin, a novolac resin, a bisphenol A resin, a bisphenol F resin, or a combination thereof. The alkali soluble resin may have a weight average molecular weight of about 1,000 g/mol to about 30,000 g/mol.

The positive photosensitive resin composition may further include an additive selected from a silane-based coupling agent, a surfactant, a leveling agent, a latent thermal acid generator, and a combination thereof.

The positive photosensitive resin composition may include about 5 parts by weight to about 100 parts by weight of the photosensitive diazoquinone compound (B) and about 200 parts by weight to about 900 parts by weight of the solvent (C) based on about 100 parts by weight of the alkali soluble resin (A).

Another embodiment provides a photosensitive resin film manufactured using the positive photosensitive resin composition.

Yet another embodiment provides a display device including the photosensitive resin film.

Other embodiments of the present invention are included in the following detailed description.

A photosensitive resin composition having a high shrinkage ratio, excellent durability and the like may be provided by using an alkali soluble resin including a particular linking group as a repeating unit, and a photosensitive resin film formed of the photosensitive resin composition may be usefully applied to a display device.

### DETAILED DESCRIPTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, when a specific definition is not otherwise provided, the term “substituted” refers to one substituted with at least one substituent including halogen (F, Cl, Br, or I), a hydroxy group, a nitro group, a cyano group, an amino group (NH₂, NH(R²⁰⁰) or N(R²⁰¹)(R²⁰²), wherein R²⁰⁰, R²⁰¹ and R²⁰² are independently C1 to C10 alkyl), an amidino group, a hydrazine group, a hydrazone group, a carboxyl group, substituted or unsubstituted C1 to C30 alkyl, substituted or unsubstituted C2 to C30 alkenyl, substituted or unsubstituted C2 to C30 alkynyl, substituted or unsubstituted C1 to C30 alkoxy, substituted or unsubstituted C6 to C30 aryl, substituted or unsubstituted C3 to C30 cycloalkyl, substituted or unsubstituted C2 to C30 heteroaryl, substituted or unsubstituted C2 to C30 heterocycloalkyl, or a combination thereof, instead of a functional group of the present invention.

As used herein, when a specific definition is not otherwise provided, the term “alkyl” refers to C1 to C30 alkyl, for example C1 to C20 alkyl, the term “cycloalkyl” refers to C3 to C30 cycloalkyl, for example C3 to C20 cycloalkyl, the term “alkoxy” refers to C1 to C30 alkoxy, for example C1 to C18 alkoxy, the term “aryl” refers to C6 to C30 aryl, for example C6 to C20 aryl, the term “alkenyl” refers to C2 to C30 alkenyl, for example C2 to C18 alkenyl, the term “alkylene” refers to C1 to C30 alkylene, for example C1 to C18 alkylene, and the term “arylene” refers to C6 to C30 arylene, for example C6 to C16 arylene.

As used herein, when a specific definition is not otherwise provided, the term “aliphatic organic group” refers to C1 to C30 alkyl, C2 to C30 alkenyl, C2 to C30 alkynyl, C1 to C30 alkylene, C2 to C30 alkenylene, or C2 to C30 alkynylene, for example C1 to C15 alkyl, C2 to C15 alkenyl, C2 to C15 alkynyl, C1 to C15 alkylene, C2 to C15 alkenylene, or C2 to C15 alkynylene, the term “alicyclic organic group” refers to C3 to C30 cycloalkyl, C3 to C30 cycloalkenyl, C3 to C30 cycloalkynyl, C3 to C30 cycloalkylene, C3 to C30 cycloalkenylene, or C3 to C30 cycloalkynylene, for example C3 to C15 cycloalkyl, C3 to C15 cycloalkenyl, C3 to C15 cycloalkynyl, C3 to C15 cycloalkylene, C3 to C15 cycloalkenylene, or C3 to C15 cycloalkynylene, the term “aromatic organic group” refers to C6 to C30 aryl or C6 to C30 arylene, for example C6 to C16 aryl or C6 to C16 arylene, and the term “hetero cyclic group” refers to C2 to C30 heterocycloalkyl, C2 to C30 heterocycloalkylene, C2 to C30 heterocycloalkenyl, C2 to C30 heterocycloalkenylene, C2 to C30 heterocycloalkynyl, C2 to C30 heterocycloalkynylene, C2 to C30 heteroaryl, or C2 to C30 heteroarylene that include 1 to 3 hetero atoms including O, S, N, P, Si, or a combination thereof in a ring, for example C2 to C15 heterocycloalkyl, C2 to C15 heterocycloalkylene, C2 to C15 heterocycloalkenyl, C2 to C15 heterocycloalkenylene, C2 to C15 heterocycloalkynyl, C2 to C15 heterocycloalkynylene, C2 to C15 heteroaryl, or C2 to C15 heteroarylene that include 1 to 3 hetero atoms including O, S, N, P, Si, or a combination thereof in a ring.

As used herein, when a specific definition is not otherwise provided, the terms “fluoroalkyl”, “fluoroalkylene”, “fluorocycloalkylene”, “fluoroarylene”, “fluoroalkoxy” and “fluoroalcohol” refer to a substituent including a fluorine atom in alkyl, alkylene, cycloalkylene, arylene, alkoxy and alcohol.

As used herein, unless a specific definition is otherwise provided, hydrogen is bonded at a position when a chemical bond is not drawn where a bond would otherwise appear.

As used herein, when a specific definition is not otherwise provided, the term “combination” refers to mixing or copolymerization.

Also, “ * ” refers to a linking part between the same or different atoms, or Chemical Formulae.

One embodiment provides a positive photosensitive resin composition that includes (A) an alkali soluble resin including a repeating unit represented by the following Chemical Formula 1; (B) a photosensitive diazoquinone compound; and (C) a solvent.

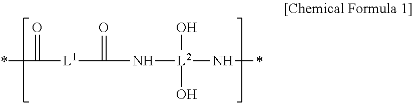

In the above Chemical Formula 1,

L¹ is represented by the following Chemical Formula 2.

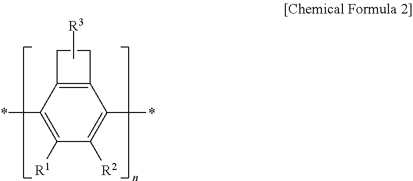

In the above Chemical Formula 2,

R¹ to R³ are the same or different and are each independently hydrogen, halogen, substituted or unsubstituted C1 to C20 alkyl, or substituted or unsubstituted C6 to C20 aryl, wherein R¹ and R² are optionally fused to each other to form a ring, and

n is an integer ranging from 1 to 10.

In the above Chemical Formula 1,

L² is a substituted or unsubstituted C6 to C30 aromatic organic group.

A linking group represented by the above Chemical Formula 2 may help a cross-linking reaction among polymer resins and adjust a taped angle to be in a range of about 35° to about 45° during curing of an alkali soluble resin composition (e.g., a positive photosensitive resin composition) after development and thus, accomplish a high shrinkage ratio, excellent durability and film characteristics. In addition, since a cross-linking agent is not added to the alkali soluble resin composition, stability may be secured without having an influence from optical properties of the cross-linking agent.

Hereinafter, each component of the positive photosensitive resin composition is described in detail.

(A) Alkali Soluble Resin

An alkali soluble resin is one constituent element of a positive photosensitive resin composition according to one embodiment and includes a repeating unit represented by the above Chemical Formula 1 and thus, may easily adjust a tapered angle and a shrinkage ratio and improve film characteristics and the like of a photosensitive resin film formed thereof.

In particular, the alkali soluble resin internally includes a linking group represented by the above Chemical Formula 2, and the linking group may work as a cross-linking agent among the alkali soluble resins. Accordingly, since polymer resins are well cross-linked without a separate cross-linking agent, a tapered angle and a shrinkage ratio may be easily adjusted, and stability and the like of the resins may be improved. However, when the linking group represented by the above Chemical Formula 2 is included only at the end of the alkali soluble resin, the alkali soluble resin may not be easily cross-linked, and a tapered angle and a shrinkage ratio may not be easily adjusted. Accordingly, the problem may be solved by separately adding a cross-linking agent and the thereto, but stability of the resin may be hardly secured.

For example, the above Chemical Formula 2 may be represented by one or more of the following Chemical Formulae 3 to 6.

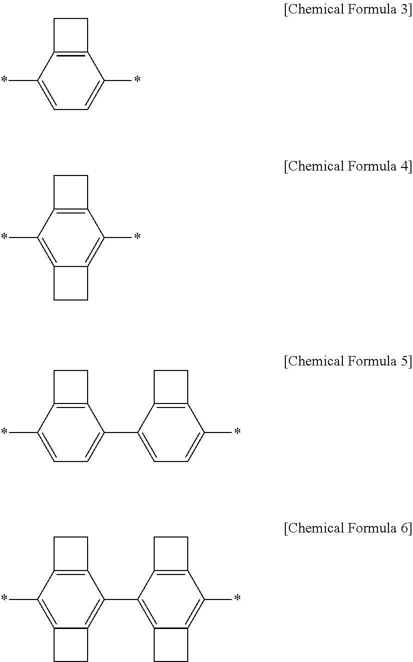 [SMILES: *c1ccc(*)c2c1CC2 ; *c1c2c(c(*)c3c1CC3)CC2 ; *c1ccc(-c2ccc(*)c3c2CC3)c2c1CC2 ; *c1c2c(c(-c3c4c(c(*)c5c3CC5)CC4)c3c1CC3)CC2]

The alkali soluble resin may include the repeating unit represented by the above Chemical Formula 1 in an amount of about 5 wt % to about 60 wt % based on the total amount (total weight, 100 wt %) of the alkali soluble resin.

In some embodiments, the alkali soluble resin may include the repeating unit represented by the above Chemical Formula 1 in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt %. Further, according to some embodiments of the present invention, the amount of the repeating unit represented by the above Chemical Formula 1 thereof can be in a range from about any of the foregoing amounts to about any other of the foregoing amounts.

The alkali soluble resin may further include a repeating unit represented by the following Chemical Formula 7, a repeating unit represented by the following Chemical Formula 8, or a combination thereof.

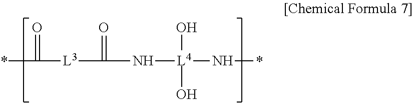

In the above Chemical Formula 7,

L³ is a substituted or unsubstituted C6 to C30 aromatic organic group, a substituted or unsubstituted divalent C1 to C30 aliphatic organic group, or a substituted or unsubstituted divalent C3 to C30 alicyclic organic group, and

L⁴ is a substituted or unsubstituted C6 to C30 aromatic organic group.

For example, the L³ may be an aromatic organic group, a divalent aliphatic organic group, or a divalent alicyclic organic group, and may be a residual group of dicarboxylic acid, or a residual group of a dicarboxylic acid derivative. In exemplary embodiments, L³ may be an aromatic organic group or a divalent alicyclic organic group.

Examples of the dicarboxylic acid include may include without limitation L³(COOH)₂ (wherein L³ is the same as L³ of the above Chemical Formula 7).

Examples of the carboxylic acid derivative include without limitation carbonyl halide derivatives of the L³(COOH)₂ and/or active compounds of an active ester derivative obtained by reacting L³(COOH)₂ with 1-hydroxy-1,2,3-benzotriazole (wherein L³ is the same as L³ of the above Chemical Formula 7).

Examples of the dicarboxylic acid derivative include without limitation 4,4′-oxydibenzoylchloride, diphenyloxydicarbonyldichloride, bis(phenylcarbonylchloride)sulfone, bis(phenylcarbonylchloride)ether, bis(phenylcarbonylchloride)phenone, phthaloyldichloride, terephthaloyldichloride, isophthaloyldichloride, dicarbonyldichloride, diphenyloxydicarboxylatedibenzotriazole, and the like, and combinations thereof.

L⁴ may be an aromatic organic group, for example a residual group derived from aromatic diamine.

Examples of the aromatic diamine may include without limitation 3,3′-diamino-4,4′-dihydroxybiphenyl, 4,4′-diamino-3,3′-dihydroxybiphenyl, bis(3-amino-4-hydroxyphenyl)propane, bis(4-amino-3-hydroxyphenyl)propane, bis(3-amino-4-hydroxyphenyl)sulfone, bis(4-amino-3-hydroxyphenyl)sulfone, 2,2-bis(3-amino-4-hydroxyphenyl)-1,1,1,3,3,3-hexafluoropropane, 2,2-bis(4-amino-3-hydroxyphenyl)-1,1,1,3,3,3-hexafluoropropane, 2,2-bis(3-amino-4-hydroxy-5-trifluoromethylphenyl)hexafluoropropane, 2,2-bis(3-amino-4-hydroxy-6-trifluoromethylphenyl)hexafluoropropane, 2,2-bis(3-amino-4-hydroxy-2-trifluoromethylphenyl)hexafluoropropane, 2,2-bis(4-amino-3-hydroxy-5-trifluoromethylphenyl)hexafluoropropane, 2,2-bis(4-amino-3-hydroxy-6-trifluoromethylphenyl)hexafluoropropane, 2,2-bis(4-amino-3-hydroxy-2-trifluoromethylphenyl)hexafluoropropane, 2,2-bis(3-amino-4-hydroxy-5-pentafluoroethylphenyl)hexafluoropropane, 2-(3-amino-4-hydroxy-5-trifluoromethylphenyl)-2-(3-amino-4-hydroxy-5-pentafluoroethylphenyl)hexafluoropropane, 2-(3-amino-4-hydroxy-5-trifluoromethylphenyl)-2-(3-hydroxy-4-amino-5-trifluoromethylphenyl)hexafluoropropane, 2-(3-amino-4-hydroxy-5-trifluoromethylphenyl)-2-(3-hydroxy-4-amino-6-trifluoromethylphenyl)hexafluoropropane, 2-(3-amino-4-hydroxy-5-trifluoromethylphenyl)-2-(3-hydroxy-4-amino-2-trifluoromethylphenyl)hexafluoropropane, 2-(3-amino-4-hydroxy-2-trifluoromethylphenyl)-2-(3-hydroxy-4-amino-5-trifluoromethylphenyl)hexafluoropropane, 2-(3-amino-4-hydroxy-6-trifluoromethylphenyl)-2-(3-hydroxy-4-amino-5-trifluoromethylphenyl)hexafluoropropane, and the like, and combinations thereof.

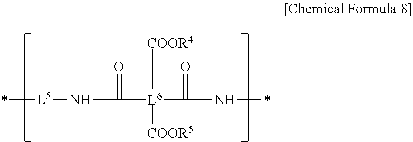

In the above Chemical Formula 8,

L⁵ is a substituted or unsubstituted C6 to C30 aromatic organic group, a substituted or unsubstituted divalent C1 to C30 aliphatic organic group, a substituted or unsubstituted divalent C3 to C30 alicyclic organic group, or an organosilane group,

L⁶ is a substituted or unsubstituted C6 to C30 aromatic organic group, a substituted or unsubstituted tetravalent C1 to C30 aliphatic organic group, or a substituted or unsubstituted tetravalent C3 to C30 alicyclic organic group, and

R⁴ and R⁵ are the same or different and are each independently hydrogen, halogen, substituted or unsubstituted C1 to C20 alkyl or substituted or unsubstituted C6 to C20 aryl.

For example, L⁵ may be a residual group derived from aromatic diamine, alicyclic diamine, and/or silicon diamine. Herein, the aromatic diamine, alicyclic diamine, and silicon diamine may be used singularly or as a mixture of one or more.

Examples of the aromatic diamine may include without limitation 3,4′-diaminodiphenylether, 4,4′-diaminodiphenylether, 3,4′-diaminodiphenylmethane, 4,4′-diaminodiphenylmethane, 4,4′-diaminodiphenylsulfone, 4,4′-diaminodiphenylsulfide, benzidine, m-phenylenediamine, p-phenylenediamine, 1,5-naphthalenediamine, 2,6-naphthalenediamine, bis[4-(4-aminophenoxy)phenyl]sulfone, bis(3-aminophenoxyphenyl)sulfone, bis(4-aminophenoxy)biphenyl, bis[4-(4-aminophenoxy)phenyl]ether, 1,4-bis(4-aminophenoxy)benzene, one or more of the forgoing compounds including an aromatic ring substituted with alkyl and/or halogen, and the like, and combinations thereof.

Examples of the alicyclic diamine may include without limitation 1,2-cyclohexyl diamine, 1,3-cyclohexyl diamine, and the like, and combinations thereof.

Examples of the silicon diamine may include without limitation bis(4-aminophenyl)dimethylsilane, bis(4-aminophenyl)tetramethylsiloxane, bis(p-aminophenyl)tetramethyldisiloxane, bis(y-aminopropyl)tetramethyldisiloxane, 1,4-bis(γ-aminopropyldimethylsilyl)benzene, bis(4-aminobutyl)tetramethyldisiloxane, bis(γ-aminopropyl)tetraphenyldisiloxane, 1,3-bis(aminopropyl)tetramethyldisiloxane, and the like, and combinations thereof.

For example, L⁶ may be a residual group derived from aromatic acid dianhydride and/or alicyclic acid dianhydride. Herein, the aromatic acid dianhydride and the alicyclic acid dianhydride may be used singularly or as a mixture of more than one.

Examples of the aromatic acid dianhydride may include without limitation benzophenone tetracarboxylic dianhydrides such as pyromellitic dianhydride, benzophenone-3,3′,4,4′-tetracarboxylic dianhydride, and the like; oxydiphthalic dianhydrides such as 4,4′-oxydiphthalic dianhydride; biphthalic dianhydrides such as 3,3′,4,4′-biphthalic dianhydride; (hexafluoroisopropyledene)diphthalic dianhydrides such as 4,4′-(hexafluoroisopropyledene)diphthalic dianhydride; naphthalene-1,4,5,8-tetracarboxylic dianhydride; 3,4,9,10-perylenetetracarboxylic dianhydride, and the like, and combinations thereof.

Examples of the alicyclic acid dianhydride may include without limitation 1,2,3,4-cyclobutanetetracarboxylic dianhydride, 1,2,3,4-cyclopentanetetracarboxylic dianhydride, 5-(2,5-dioxotetrahydrofuryl)-3-methyl-cyclohexane-1,2-dicarboxylic anhydride, 4-(2,5-dioxotetrahydrofuran-3-yl)-tetralin-1,2-dicarboxylic anhydride, bicyclooctene-2,3,5,6-tetracarboxylic dianhydride, bicyclooctene-1,2,4,5-tetracarboxylic dianhydride, and the like, and combinations thereof.

The alkali soluble resin may further include an acrylic-based resin, a novolac resin, a bisphenol A resin, a bisphenol F resin, or a combination thereof.

The acrylic-based resin is a copolymer of a first ethylenic unsaturated monomer and a second ethylenic unsaturated monomer that is copolymerizable therewith, and is a resin including at least one acrylic-based repeating unit.

The first ethylenic unsaturated monomer is an ethylenic unsaturated monomer including at least one carboxyl group. Examples of the monomer include without limitation (meth)acrylic acid, maleic acid, itaconic acid, fumaric acid, and the like, and combinations thereof.

The acrylic-based resin may include the first ethylenic unsaturated monomer in an amount of about 5 to about 50 wt %, for example about 10 to about 40 wt %, based on the total amount (total weight, 100 wt %) of the acrylic-based resin.

Examples of the second ethylenic unsaturated monomer may include without limitation aromatic vinyl compounds such as styrene, α-methylstyrene, vinyl toluene, vinylbenzylmethylether and the like; unsaturated carboxylate ester compounds such as methyl(meth)acrylate, ethyl(meth)acrylate, butyl(meth)acrylate, 2-hydroxyethyl(meth)acrylate, 2-hydroxy butyl(meth)acrylate, benzyl(meth)acrylate, cyclohexyl(meth)acrylate, phenyl(meth)acrylate, and the like; unsaturated carboxylic acid amino alkyl ester compounds such as 2-aminoethyl(meth)acrylate, 2-dimethylaminoethyl(meth)acrylate, and the like; carboxylic acid vinyl ester compounds such as vinyl acetate, vinyl benzoate, and the like; unsaturated carboxylic acid glycidyl ester compounds such as glycidyl(meth)acrylate, and the like; vinyl cyanide compounds such as (meth)acrylonitrile and the like; unsaturated amide compounds such as (meth)acrylamide, and the like; and the like, and may be used singularly or as a mixture of two or more.

Specific examples of the acrylic-based resin may include without limitation an acrylic acid/benzylmethacrylate copolymer, a methacrylic acid/benzylmethacrylate copolymer, a methacrylic acid/benzylmethacrylate/styrene copolymer, a methacrylic acid/benzylmethacrylate/2-hydroxyethylmethacrylate copolymer, a methacrylic acid/benzylmethacrylate/styrene/2-hydroxyethylmethacrylate copolymer, and the like. These may be used singularly or as a mixture of two or more.

The alkali soluble resin may have a weight average molecular weight of about 1,000 g/mol to about 30,000 g/mol, for example about 3,000 g/mol to about 20,000 g/mol. When the alkali soluble resin has a weight average molecular weight within the above range, a sufficient film residue ratio in a non-exposed region may be obtained during development with an alkali aqueous solution, and efficient patterning may be performed.

(B) Photosensitive Diazoquinone Compound

The photosensitive diazoquinone compound may be a compound having a 1,2-benzoquinone diazide structure and/or 1,2-naphthoquinone diazide structure.

The photosensitive diazoquinone compound may include at least one or more compounds represented by the following Chemical Formulae 19 and 21 to 23, but is not limited thereto.

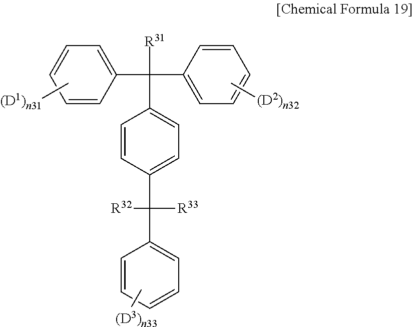

In the above Chemical Formula 19,

R³¹ to R³³ are the same or different and are each independently hydrogen or substituted or unsubstituted alkyl, for example CH₃,

D¹ to D³ are the same or different and are each independently OQ, wherein Q is hydrogen, a functional group represented by the following Chemical Formula 20a, or a functional group represented by the following Chemical Formula 20b, provided that all Qs are not simultaneously hydrogen, and

n31 to n33 are the same or different and are each independently integers of 1 to 5.

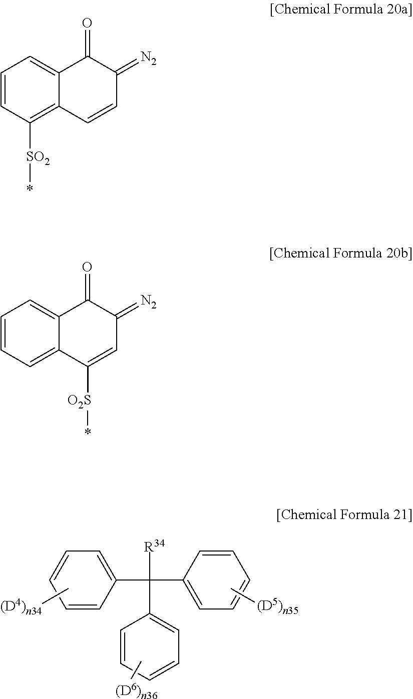

In the above Chemical Formula 21,

R³⁴ is hydrogen or substituted or unsubstituted alkyl,

D⁴ to D⁶ are the same or different and are each independently OQ, wherein Q is the same as defined in the above 19, and

n34 to n36 are the same or different and are each independently integers of 1 to 5.

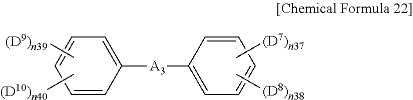

In the above Chemical Formula 22,

A3 is CO or CR⁵⁰⁰R⁵⁰¹, wherein R⁵⁰⁰ and R⁵⁰¹ are the same or different and are each independently substituted or unsubstituted alkyl,

D⁷ to D¹⁰ are the same or different and are each independently hydrogen, substituted or unsubstituted alkyl, OQ, or NHQ, wherein Q is the same as defined in the above Chemical Formula 19,

n37, n38, n39 and n40 are the same or different and are each independently integers of 1 to 4, and

n37+n38 and n39+n40 are the same or different and are each independently integers of less than or equal to 5,

provided that at least one of D⁷ to D¹⁰ is OQ, and one aromatic ring includes one to three OQs and the other aromatic ring includes one to four OQs.

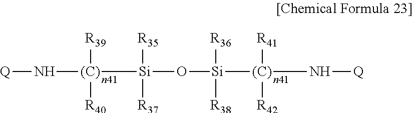

In the above Chemical Formula 23,

R₃₅ to R₄₂ are the same or different and are each independently hydrogen or substituted or unsubstituted alkyl,

n41 and n42 are the same or different and are each independently integers of 1 to 5, for example 2 to 4, and

Q is the same as defined above Chemical Formula 19.

The positive photosensitive resin composition may include the photosensitive diazoquinone compound in an amount of about 5 to about 100 parts by weight, for example about 10 to about 50 parts by weight, based on about 100 parts by weight of the alkali soluble resin. In some embodiments, the positive photosensitive resin composition may include the photosensitive diazoquinone compound in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 parts by weight. Further, according to some embodiments of the present invention, the amount of the photosensitive diazoquinone compound can be in a range from about any of the foregoing amounts to about any other of the foregoing amounts.

When the photosensitive diazoquinone compound is included in an amount within the above range, the pattern can be well-formed with minimal or no residue from exposure, and a film thickness loss during development may be prevented and thereby a good pattern can be provided.

(C) Solvent

The positive photosensitive resin composition may include a solvent that is capable of easily dissolving each component of the alkali soluble resin, photosensitive diazoquinone compound, and the like.

The solvent may be an organic solvent. Examples of the organic solvent may include without limitation N-methyl-2-pyrrolidone, gamma-butyrolactone, N,N-dimethylacetamide, dimethylsulfoxide, diethylene glycoldimethylether, diethylene glycoldiethylether, diethylene glycoldibutylether, propylene glycolmonomethylether, dipropylene glycolmonomethylether, propylene glycolmonomethyl ether acetate, methyl lactate, ethyl lactate, butyl lactate, methyl-1,3-butylene glycolacetate, 1,3-butylene glycol-3-monomethylether, methyl pyruvate, ethyl pyruvate, methyl-3-methoxy propionate, and the like, and combinations thereof.

The solvent may be selected based on the process used for forming a photosensitive resin film, such as but not limited to spin coating, slit die coating, and the like.

The positive photosensitive resin composition may include the solvent in an amount of about 200 parts by weight to about 900 parts by weight, for example about 200 parts by weight to about 700 parts by weight, based on about 100 parts by weight of the alkali soluble resin. When the solvent is included in an amount within the above range, a coating layer may have a sufficient thickness, and excellent solubility and coating properties can be improved.

(D) Other Additive(s)

The positive photosensitive resin composition according to one embodiment may further include one or more other additives.

Examples of the additives may include without limitation malonic acid; 3-amino-1,2-propanediol; silane coupling agents having a vinyl group or a (meth)acryloxy group, and the like, and combinations thereof, in order to prevent a stain of the film during coating, provide leveling improvement, or prevent residues generation due to non-development. The amount of the additive may be controlled depending on desired properties.

The positive photosensitive resin composition may further include an epoxy compound in order to improve adherence with a substrate. Examples of the epoxy compound may include without limitation epoxy novolac acryl carboxylate resins, ortho cresol novolac epoxy resins, phenol novolac epoxy resins, tetramethyl biphenyl epoxy resins, bisphenol A epoxy resins, alicyclic epoxy resins, and the like, and combinations thereof.

When the epoxy compound is further used, a radical polymerization initiator such as a peroxide initiator and/or an azobis-based initiator may be further used.

The positive photosensitive resin composition may include the epoxy compound in an amount of about 0.01 to about 5 parts by weight based on about 100 parts by weight of the positive photosensitive resin composition. When the epoxy compound is used in an amount within the above range, storage and adherence and other characteristics may be improved economically.

In addition, the positive photosensitive resin composition may further include a latent thermal acid generator. Examples of the latent thermal acid generator may include without limitation aryl sulfonic acids such as p-toluene sulfonic acid, benzene sulfonic acid, and the like; perfluoroalkyl sulfonic acids such as trifluoromethane sulfonic acid, trifluorobutane sulfonic acid, and the like; alkyl sulfonic acids such as methane sulfonic acid, ethane sulfonic acid, butane sulfonic acid, and the like; and the like, and combinations thereof.

The latent thermal acid generator is a catalyst for a dehydration reaction and a cyclization reaction of the polybenzoxazole precursor that is polyamide including a phenolic hydroxy group, and thus a cyclization reaction may be performed smoothly even if a curing temperature is decreased.

In addition, an additive such as a suitable surfactant and/or leveling agent may be included in order to prevent a stain of the film and/or to improve the development.

A patterning process using the positive photosensitive resin composition may include coating the positive photosensitive resin composition on a support substrate in a method of spin coating, slit coating, inkjet printing, and the like; drying the coated positive photosensitive resin composition to form a positive photosensitive resin composition film; exposing the positive photosensitive resin composition film to light; developing the exposed positive photosensitive resin composition film in an alkali aqueous solution to obtain a photosensitive resin film such as an insulation layer; and heat-treating the photosensitive resin film. Conditions for the patterning process are well known in the art and will not be illustrated in detail herein.

According to another embodiment, a photosensitive resin film prepared using the positive photosensitive resin composition is provided.

According to yet embodiment, a display device including the photosensitive resin film is provided. The display device may be a liquid crystal display, a light emitting diode, a plasma display, and/or an organic light emitting diode (OLED).

The positive photosensitive resin composition may be used for forming an insulation layer, a passivation layer, and/or a buffer coating layer in a display device. That is to say, the positive photosensitive resin composition may be used for forming a surface protective layer and/or an interlayer insulating layer in a display device.

Hereinafter, the present invention is illustrated in more detail with reference to the following examples and comparative examples. However, the following examples and comparative examples are provided for the purpose of illustration only and the present invention is not limited thereto.

### EXAMPLE

### Synthesis of Alkali Soluble Resin

### Synthesis Example 1

12.4 g of 2,2-bis(3-amino-4-hydroxyphenyl)-1,1,1,3,3,3-hexafluoropropane is put along with 125 g of N-methyl-2-pyrrolidone (NMP) in a four-necked flask equipped with an agitator, a temperature controller, a nitrogen gas injector and a condenser and dissolved therein, while nitrogen is passed through the flask.

When the solid is completely dissolved, 4.2 g of pyridine as a catalyst is added thereto, and a solution obtained by dissolving 6.9 g of 4,4′-oxydibenzoylchloride and 1.6 g of a monomer represented by the following Chemical Formula A in 100 g of NMP while the temperature is maintained at 0° C. to 5° C. is slowly added to the four-necked flask in a dropwise fashion for 30 minutes. When the addition is complete, the mixture is reacted for 1 hour at 0° C. to 5° C. and then, at room temperature for one hour more after increasing the temperature up to the room temperature.

Then, 1.1 g of 5-norbornene-2,3-dicarboxyl anhydride is added to the resultant, and the obtained mixture is agitated at 70° C. for 24 hours, completing the reaction. The reaction mixture is added to a solution obtained by mixing water and methanol (a volume ratio of 10/1) to produce a precipitate, and an alkali soluble resin is manufactured by filtering the precipitate and then, washing it with water and drying it at 80° C. under vacuum for greater than or equal to 24 hours.

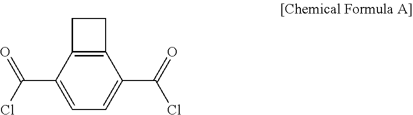 [SMILES: O=C(Cl)c1ccc(C(=O)Cl)c2c1CC2]

### Synthesis Example 2

An alkali soluble resin is manufactured according to the same method as Synthesis Example 1 except for using 2.6 g of a monomer represented by the above Chemical Formula A and 5.6 g of 4,4′-oxydibenzoylchloride.

### Synthesis Example 3

An alkali soluble resin is manufactured according to the same method as Synthesis Example 1 except for using 7.0 g of a monomer represented by the above Chemical Formula A but no 4,4′-oxydibenzoylchloride.

### Synthesis Example 4

An alkali soluble resin is manufactured according to the same method as Synthesis Example 1 except for using 1.8 g of a monomer represented by the above Chemical Formula B instead of the monomer represented by the above Chemical Formula A.

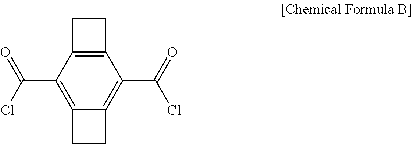 [SMILES: O=C(Cl)c1c2c(c(C(=O)Cl)c3c1CC3)CC2]

### Synthesis Example 5

An alkali soluble resin is manufactured according to the same method as Synthesis Example 2 except for using 2.9 g of a monomer represented by the above Chemical Formula B instead of the monomer represented by the above Chemical Formula A.

### Synthesis Example 6

An alkali soluble resin is manufactured according to the same method as Synthesis Example 3 except for using 7.8 g of a monomer represented by the above Chemical Formula B instead of the monomer represented by the above Chemical Formula A.

### Synthesis Example 7

An alkali soluble resin is manufactured according to the same method as Synthesis Example 1 except for using 2.3 g of a monomer represented by the above Chemical Formula C instead of the monomer represented by the above Chemical Formula A.

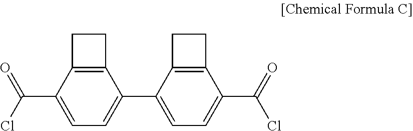 [SMILES: O=C(Cl)c1ccc(-c2ccc(C(=O)Cl)c3c2CC3)c2c1CC2]

### Synthesis Example 8

An alkali soluble resin is manufactured according to the same method as Synthesis Example 2 except for using 3.8 g of a monomer represented by the above Chemical Formula C instead of the monomer represented by the above Chemical Formula A.

### Synthesis Example 9

An alkali soluble resin is manufactured according to the same method as Synthesis Example 3 except for using 10.1 g of a monomer represented by the above Chemical Formula C instead of the monomer represented by the above Chemical Formula A.

### Synthesis Example 10

An alkali soluble resin is manufactured according to the same method as Synthesis Example 1 except for using 2.7 g of a monomer represented by the above Chemical Formula D instead of the monomer represented by the above Chemical Formula A.

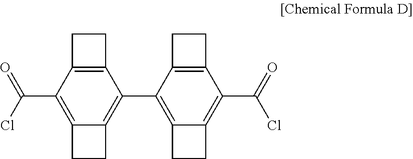 [SMILES: O=C(Cl)c1c2c(c(-c3c4c(c(C(=O)Cl)c5c3CC5)CC4)c3c1CC3)CC2]

### Synthesis Example 11

An alkali soluble resin is manufactured according to the same method as Synthesis Example 2 except for using 4.4 g of a monomer represented by the above Chemical Formula D instead of the monomer represented by the above Chemical Formula A.

### Synthesis Example 12

An alkali soluble resin is manufactured according to the same method as Synthesis Example 3 except for using 11.7 g of a monomer represented by the above Chemical Formula D instead of the monomer represented by the above Chemical Formula A.

### Comparative Synthesis Example 1

An alkali soluble resin is manufactured according to the same method as Synthesis Example 1 except for using 9.0 g of 4,4′-oxydibenzoylchloride instead of the monomer represented by the above Chemical Formula A.

### Comparative Synthesis Example 2

An alkali soluble resin is manufactured according to the same method as Synthesis Example 1 except for mixing a solution obtained by dissolving 9.0 g of 4,4′-oxydibenzoylchloride in 90 g of NMP and reacting them for one hour with another solution obtained by putting 1.1 g of a monomer represented by Chemical Formula A in 10 g of NMP and reacting them for 1 hour instead of dissolving 6.9 g of 4,4′-oxydibenzoylchloride and 1.6 g of a monomer represented by the following Chemical Formula A in 100 g of NMP.

### Preparation of Positive Photosensitive Resin Composition

### Example 1

10 g of the alkali soluble resin obtained according to Synthesis Example 1 is added to 35.0 g of y-butyrolactone (GBL) and dissolved therein, 3.0 g of a photosensitive diazoquinone compound having a structure of the following Chemical Formula E is added thereto and dissolved therein, and the solution is filtered through a 0.45 μm fluororesin filter, obtaining a positive photosensitive resin composition.

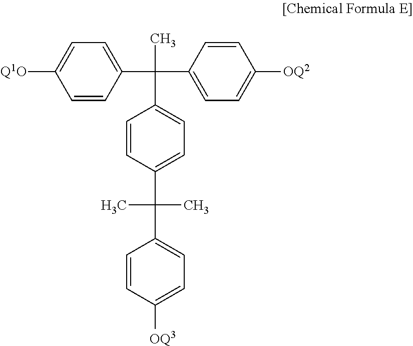

In the above Chemical Formula E, two of Q¹, Q² and Q³ are substituted with

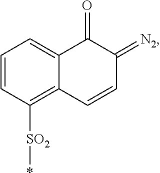

and the other one is hydrogen.

### Example 2

A positive photosensitive resin composition is obtained according to the same method as Example 1 except for using the alkali soluble resin of Synthesis Example 2 instead of the alkali soluble resin of Synthesis Example 1.

### Example 3

A positive photosensitive resin composition is manufactured according to the same method as Example 1 except for using the alkali soluble resin of Synthesis Example 3 instead of the alkali soluble resin of Synthesis Example 1.

### Example 4

A positive photosensitive resin composition is manufactured according to the same method as Example 1 except for using the alkali soluble resin of Synthesis Example 4 instead of the alkali soluble resin of Synthesis Example 1.

### Example 5

A positive photosensitive resin composition is manufactured according to the same method as Example 1 except for using the alkali soluble resin of Synthesis Example 5 instead of the alkali soluble resin of Synthesis Example 1.

### Example 6

A positive photosensitive resin composition is manufactured according to the same method as Example 1 except for using the alkali soluble resin of Synthesis Example 6 instead of the alkali soluble resin of Synthesis Example 1.

### Example 7

A positive photosensitive resin composition is manufactured according to the same method as Example 1 except for using the alkali soluble resin of Synthesis Example 7 instead of the alkali soluble resin of Synthesis Example 1.

### Example 8

A positive photosensitive resin composition is manufactured according to the same method as Example 1 except for using the alkali soluble resin of Synthesis Example 8 instead of the alkali soluble resin of Synthesis Example 1.

### Example 9

A positive photosensitive resin composition is manufactured according to the same method as Example 1 except for using the alkali soluble resin of Synthesis Example 9 instead of the alkali soluble resin of Synthesis Example 1.

### Example 10

A positive photosensitive resin composition is manufactured according to the same method as Example 1 except for using the alkali soluble resin of Synthesis Example 10 instead of the alkali soluble resin of Synthesis Example 1.

### Example 11

A positive photosensitive resin composition is manufactured according to the same method as Example 1 except for using the alkali soluble resin of Synthesis Example 11 instead of the alkali soluble resin of Synthesis Example 1.

### Example 12

A positive photosensitive resin composition is manufactured according to the same method as Example 1 except for using the alkali soluble resin of Synthesis Example 12 instead of the alkali soluble resin of Synthesis Example 1.

### Comparative Example 1

A positive photosensitive resin composition is manufactured according to the same method as Example 1 except for using the alkali soluble resin of Comparative Synthesis Example 1 instead of the alkali soluble resin of Synthesis Example 1.

### Comparative Example 2

A positive photosensitive resin composition is manufactured according to the same method as Example 1 except for using the alkali soluble resin of Comparative Synthesis Example 2 instead of the alkali soluble resin of Synthesis Example 1.

### Evaluation: Shrinkage Ratio and Tapered Angle

The positive photosensitive resin compositions according to Examples 1 to 12 and Comparative Examples 1 and 2 are respectively coated on a 8 inch wafer with a spin coater (1H-DX2) made by Mikasa Co., Ltd. and heated on a hot plate at 120° C. for 2 minutes, forming each photosensitive resin film.

The photosensitive resin film is exposed to light by using a mask having variously-sized patterns with an i-line stepper (NSRi10C) made by Nikon Corp. and developed in a 2.38 wt % tetramethylammonium hydroxide (TMAH) aqueous solution at room temperature for 80 seconds (2 puddles) to dissolve and remove an exposed part and then, washed with pure water for 30 seconds, obtaining a pattern. Subsequently, the obtained pattern is cured under a nitrogen atmosphere at 250° C. for 60 minutes, manufacturing a film having the pattern.

Thickness change of the film is measured by using a ST4000-DLX equipment made by K-mac, CD of the film is measured by using S-9260 made by Hitachi Ltd., and shrinkage ratio of the film is calculated according to the following equation 1.

Shrinkage ratio=(film thickness after curing/film thickness before curing)×100 [Equation 1]

The evaluation results are provided in the following Table 1.

TABLE 1

| | Shrinkage ratio (%) | Tapered angle (°) |
|---|---|---|
| Example 1 | 77 | 36 |
| Example 2 | 81 | 42 |
| Example 3 | 84 | 44 |
| Example 4 | 80 | 41 |
| Example 5 | 82 | 42 |
| Example 6 | 85 | 44 |
| Example 7 | 80 | 42 |
| Example 8 | 86 | 44 |
| Example 9 | 88 | 46 |
| Example 10 | 79 | 41 |
| Example 11 | 82 | 43 |
| Example 12 | 85 | 44 |
| Comparative Example 1 | 75 | 32 |
| Comparative Example 2 | 76 | 34 |

As shown in Table 1, Examples 1 to 12 respectively using the alkali soluble resin internally including a repeating unit represented by Chemical Formula 1 turned out to be adjusted to have a tapered angle in a range of about 35° to about 45° and a high shrinkage ratio, compared with Comparative Example 1 using an alkali soluble resin including no repeating unit represented by Chemical Formula 1 and Comparative Example 2 using an alkali soluble resin including a linking group represented by Chemical Formula 2 at the end.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting the present invention in any way.

What is claimed is:

1. A positive photosensitive resin composition, comprising:
(A) an alkali soluble resin including a repeating unit represented by the following Chemical Formula 1;
(B) a photosensitive diazoquinone compound; and
(C) a solvent: 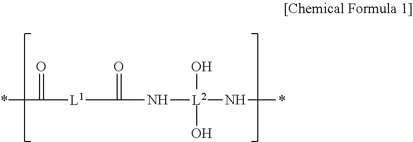
wherein, in the above Chemical Formula 1,
L¹ is represented by the following Chemical Formula 2, and
L² is a substituted or unsubstituted C6 to C30 aromatic organic group, 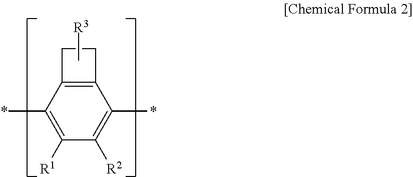
wherein, in the above Chemical Formula 2,
R¹ to R³ are the same or different and are each independently hydrogen, halogen, substituted or unsubstituted C1 to C20 alkyl, or substituted or unsubstituted C6 to C20 aryl, wherein R¹ and R² are optionally fused to each other to form a ring, and
n is an integer ranging from 1 to 10.

2. The positive photosensitive resin composition of claim 1, wherein the above Chemical Formula 2 is represented by one or more of the following Chemical Formulae 3 to 6.

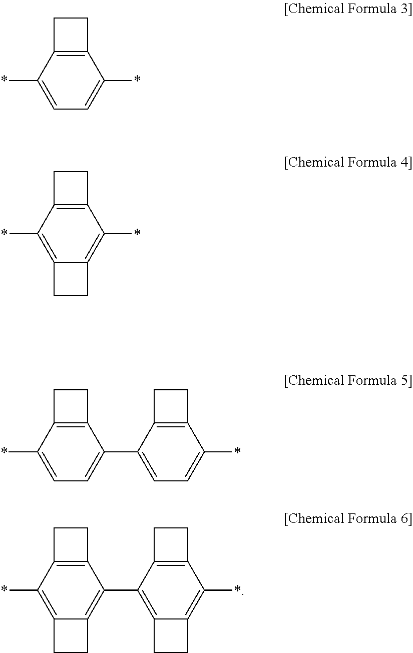

3. The positive photosensitive resin composition of claim 1, wherein the alkali soluble resin includes a repeating unit represented by Chemical Formula 1 in an amount of about 5 wt % to about 60 wt % based on the total weight of the alkali soluble resin.

4. The positive photosensitive resin composition of claim 1, wherein the alkali soluble resin further comprises a repeating unit represented by the following Chemical Formula 7, a repeating unit represented by the following Chemical Formula 8, or a combination thereof: 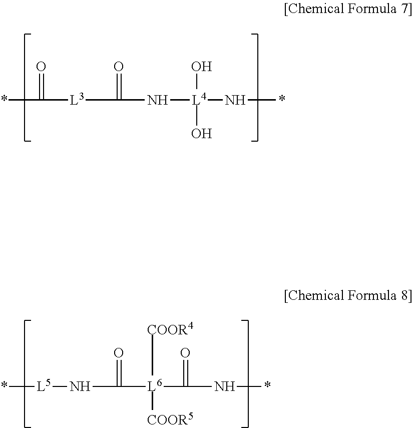
wherein, in the above Chemical Formulae 7 and 8,
L³ is a substituted or unsubstituted C6 to C30 aromatic organic group, a substituted or unsubstituted divalent C1 to C30 aliphatic organic group, or a substituted or unsubstituted divalent C3 to C30 alicyclic organic group,
L⁴ is a substituted or unsubstituted C6 to C30 aromatic organic group,
L⁵ is a substituted or unsubstituted C6 to C30 aromatic organic group, a substituted or unsubstituted divalent C1 to C30 aliphatic organic group, a substituted or unsubstituted divalent C3 to C30 alicyclic organic group, or an organosilane group,
L⁶ is a substituted or unsubstituted C6 to C30 aromatic organic group, a substituted or unsubstituted tetravalent C1 to C30 aliphatic organic group, or a substituted or unsubstituted tetravalent C3 to C30 alicyclic organic group, and
R⁴ and R⁵ are the same or different and are each independently hydrogen, halogen, substituted or unsubstituted C1 to C20 alkyl, or substituted or unsubstituted C6 to C20 aryl.

5. The positive photosensitive resin composition of claim 1, wherein the alkali soluble resin further comprises an acrylic-based resin, a novolac resin, a bisphenol A resin, a bisphenol F resin, or a combination thereof.

6. The positive photosensitive resin composition of claim 1, wherein the alkali soluble resin has a weight average molecular weight of about 1,000 g/mol to about 30,000 g/mol.

7. The positive photosensitive resin composition of claim 1, wherein the positive photosensitive resin composition further comprises a silane-based coupling agent, a surfactant, a leveling agent, a latent thermal acid generator, or a combination thereof.

8. The positive photosensitive resin composition of claim 1, wherein the positive photosensitive resin composition comprises:
about 5 parts by weight to about 100 parts by weight of the photosensitive diazoquinone compound (B), and
about 200 parts by weight to about 900 parts by weight of the solvent (C), each based on about 100 parts by weight of the alkali soluble resin (A).

9. A photosensitive resin film manufactured using the positive photosensitive resin composition of claim 1.

10. A display device comprising the photosensitive resin film of claim 9.
